(19) United States
(12) Patent Application Publication
(10) Pub. No.: US 2023/0385441 A1
(43) Pub. Date: Nov. 30, 2023

(54) USING PRIVACY BUDGET TO TRAIN MODELS FOR CONTROLLING AUTONOMOUS VEHICLES

(71) Applicant: GM Cruise Holdings LLC, San Francisco, CA (US)

(72) Inventor: Burkay Donderici, Burlingame, CA (US)

(73) Assignee: GM Cruise Holdings LLC, San Francisco, CA (US)

(21) Appl. No.: 17/828,324

(22) Filed: May 31, 2022

(51) Int. Cl. G06F 21/62; B60W 60/00

(52) U.S. Cl. CPC G06F 21/6245; B60W 60/001

(57) ABSTRACT

A model for controlling an AV can be trained with a privacy budget. A data set that includes sensor data collected by an AV from an environment around the AV is received. A privacy score of the data set is determined. The privacy score indicates a measurement of privacy information included in the data set. The privacy score may be compared with the privacy budget to determine whether the data set meets the privacy budget. After a determination that the data set does not meet the privacy budget, the data set is adjusted, e.g., by adjusting one or more objects captured by the sensor data. An example adjustment to an object may include removing or modifying a private feature of the object. The adjust data set has a privacy score that falls in the privacy budget and can be used as a privacy-protected data set to train the model.

### TECHNICAL FIELD OF THE DISCLOSURE

The present disclosure relates generally to autonomous vehicles (AVs) and, more specifically, to using privacy budget to train models for controlling AVs.

### BACKGROUND

An AV is a vehicle that is capable of sensing and navigating its environment with little or no user input. An autonomous vehicle may sense its environment using sensing devices such as Radio Detection and Ranging (RADAR), Light Detection and Ranging (LIDAR), image sensors, cameras, and the like. An autonomous vehicle system may also use information from a global positioning system (GPS), navigation systems, vehicle-to-vehicle communication, vehicle-to-infrastructure technology, and/or drive-by-wire systems to navigate the vehicle. As used herein, the phrase “autonomous vehicle” includes both fully autonomous and semi-autonomous vehicles.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a system including a fleet of AVs and a fleet management system, according to some embodiments of the present disclosure;

FIG. 2 is a block diagram showing a sensor suite, according to some embodiments of the present disclosure;

FIG. 3 is a block diagram showing a fleet management system, according to some embodiments of the present disclosure;

FIG. 4 is a block diagram showing a learning module of the fleet management system, according to some embodiments of the present disclosure;

FIG. 5 is a block diagram showing an onboard computer, according to some embodiments of the present disclosure;

FIG. 6 illustrates a scene in which in which an AV collects sensor data, according to some embodiments of the present disclosure;

FIG. 7 illustrates training a model by using knowledge distillation, according to some embodiments of the present disclosure; and

FIG. 8 is a flowchart showing a method of training an AV control model with a privacy budget, according to some embodiments of the present disclosure.

### DESCRIPTION OF EXAMPLE EMBODIMENTS OF THE DISCLOSURE

### Overview

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

AVs collect lots of data as they travel, e.g., by using sensors implemented on the AVs. The data can include valuable information for improving performance of AVs, such as information that can be used to train models for controlling AVs. Such models are referred to as “AV control models” or “control models.” However, privacy can be a concern in the usage of the data, as the data often can capture private information, which if disclosed, can result in a loss of privacy, security, or some other benefit. Also, the disclosure or usage of such private information may violate laws, regulations, or company policies. Therefore, it is important to take privacy protection into consideration when data collected by AVs are used to train AV control models.

As described herein, an AV control model is trained with a privacy budget. An AV collects sensor data in an environment around the AV. The sensor data can capture one or more objects present in the environment. The privacy budget may be determined based on privacy policies associated with the environment, such as laws, regulations, or other rules of the region where the environment is located. The privacy budget may be determined further based on privacy policies associated with the AV, such as privacy policies of an organization associated with the AV, such as the producer or provider of the AV. The privacy budget can be used to ensure that the usage of the sensor data for training the AV control model would not violate the privacy policies.

A data set that includes the sensor data can be formed, e.g., by a sensor suite or onboard computer of the AV. The data set may also include other data, such as information indicating identification of the objects. A privacy score of the data set is determined. The privacy score indicates a measurement of privacy information (e.g., a measurement of an amount of privacy information) included in the data set. In some embodiments, the privacy score is an aggregation of individual scores of the objects captured by the data set. An individual score of an object indicates a measurement of privacy information (e.g., a measurement of an amount of privacy information) in the object. The privacy score may be then compared with the privacy budget to determine whether the data set exceeds the privacy budget, e.g., by determining whether the privacy score is higher than the privacy budget.

After a determination that the data set exceeds the privacy budget, the data set is adjusted, e.g., by adjusting some or all of the objects captured by the sensor data. An example adjustment to an object may include removing or modifying a private feature of the object. The adjusted data set has a privacy score within the privacy budget and can be used as a privacy-protected data set to train the model. The model may be a neural network and may be trained through knowledge distillation. For instance, the model is trained by using knowledge distilled from a pre-trained larger network and the privacy-protected data set. The model may be trained by an AV, e.g., the AV that collects the sensor data or another AV, or an external system, such as a fleet management system that manages a fleet of AVs. The training of the AV may be conducted in or near an environment where the sensor data is collected, and the privacy can be protected near the source of the data. The trained model may be used in an environment that is different from the environment where the sensor data is collected.

As will be appreciated by one skilled in the art, aspects of the present disclosure, in particular aspects of AV sensor calibration, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, or features are described below in connection with various example embodiments, these are merely examples used to simplify the present disclosure and are not intended to be limiting.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive or and not to an exclusive or.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

### Example AV Environment

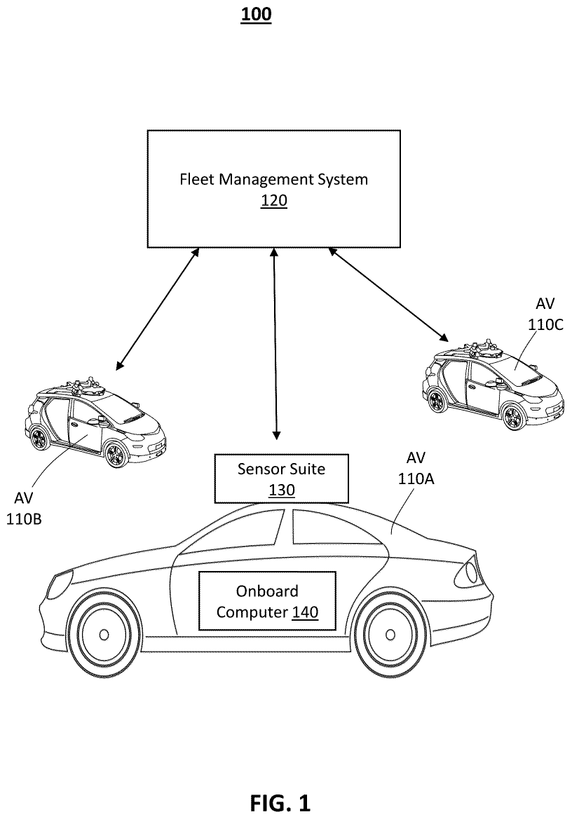

FIG. 1 illustrates a system 100 including a fleet of AVs 110A-C (collectively referred to as “AV 110” or “AVs 110”) and a fleet management system 120, according to some embodiments of the present disclosure. For purpose of simplicity and illustration, in FIG. 1, the AV 110A includes a sensor suite 130 and an onboard computer 140. The AV 110B or 110C may also include a sensor suite 130 and an onboard computer 140. In other embodiments, the system 100 may include fewer, more, or different components. For instance, the system 100 may include a different number of AVs 110 or a different number of fleet management systems 120.

The AV 110 may be a fully autonomous automobile, but may additionally or alternatively be any semi-autonomous or fully autonomous vehicle; e.g., a boat, an unmanned aerial vehicle, a driverless car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle. In some embodiments, some or all of the vehicle fleet managed by the fleet management system 120 are non-autonomous vehicles dispatched by the fleet management system 120, and the vehicles are driven by human drivers according to instructions provided by the fleet management system 120.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., windshield wipers, headlights, turn indicators, air conditioning, etc.

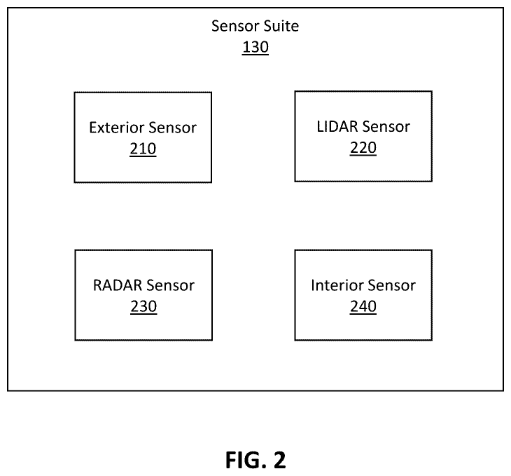

The sensor suite 130 includes one or more sensors that can detect an environment surrounding the AV 110, such as a scene in which the AV 110 navigates. The sensor suite 130 can detect objects in the environment. The sensor suite 130 may include a computer vision (“CV”) system, localization sensors, and driving sensors. For example, the sensor suite 130 may include interior and exterior cameras, RADAR sensors, sonar sensors, LIDAR sensors, thermal sensors, wheel speed sensors, inertial measurement units (IMUS), accelerometers, microphones, strain gauges, pressure monitors, barometers, thermometers, altimeters, ambient light sensors, etc. The sensors may be located in various positions in and around the AV 110. For example, the AV 110 may have multiple cameras located at different positions around the exterior and/or interior of the AV 110. More information regarding the sensor suite 130 is provided below in conjunction with FIG. 2.

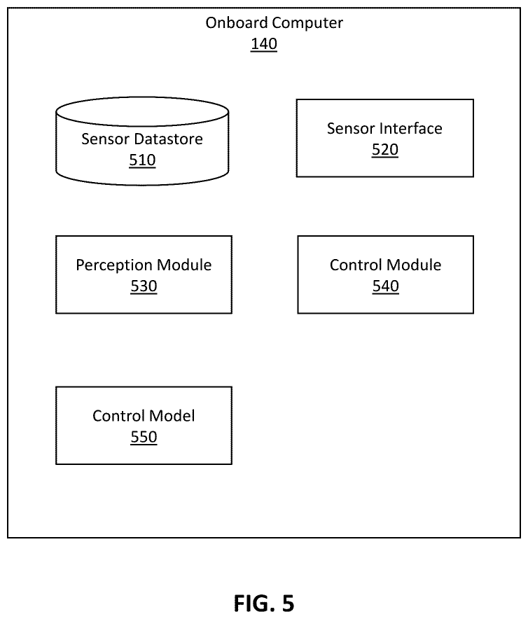

The onboard computer 140 is connected to the sensor suite 130 and functions to control the AV 110 and to process sensed data from the sensor suite 130 and/or other sensors in order to determine the state of the AV 110. Based upon the vehicle state and programmed instructions, the onboard computer 140 modifies or controls behavior of the AV 110. The onboard computer 140 is preferably a general-purpose computer adapted for I/O communication with vehicle control systems and sensor suite 130, but may additionally or alternatively be any suitable computing device. The onboard computer 140 is preferably connected to the Internet via a wireless connection (e.g., via a cellular data connection). Additionally or alternatively, the onboard computer 140 may be coupled to any number of wireless or wired communication systems. In some embodiments, the onboard computer 140 uses a trained model to control the AV 110. Such model is also referred to as a “control model” or “AV control model.” For instance, the onboard computer 140 may provide sensor data and/or data generated based on the sensor data into the model, and the model outputs operation parameters. The AV 110 may operate based on the operation parameters output from the model. For example, the onboard computer 140 may use the output of the model for perception (e.g., classification of objects, etc.), prediction (e.g., prediction of traffic condition, etc.), planning, localization, navigation, or other types of operation of the AV. More information regarding the onboard computer 140 is provided below in conjunction with FIG. 5.

The fleet management system 120 manages the fleet of AVs 110. The fleet management system 120 may manage one or more services that provides or uses the AVs, e.g., ride service, delivery service, or other types of services. The fleet management system 120 selects one or more AVs (e.g., AV 110A) from a fleet of AVs 110 to perform a particular service or other task, and instructs the selected AV to provide the service. The fleet management system 120 may also send the selected AV information that the selected AV may use to complete the service. The fleet management system 120 also manages fleet maintenance tasks, such as fueling, inspecting, calibrating, and servicing of the AVs. As shown in FIG. 1, the AVs 110 communicate with the fleet management system 120. The AVs 110 and fleet management system 120 may connect over a public network, such as the Internet.

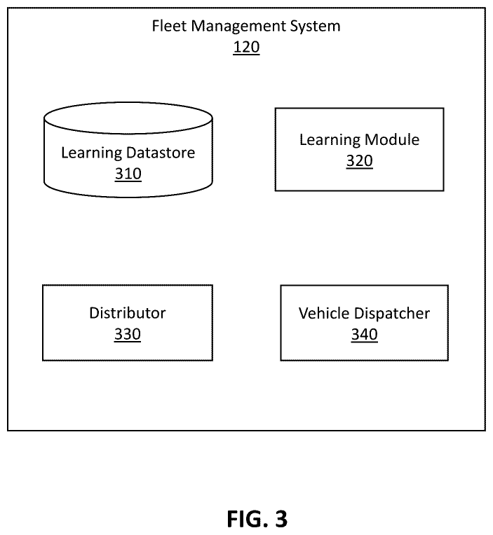

The fleet management system 120 may also train AV control models with privacy-protected data and distribute the AV control models to the fleet of AVs 110. In some embodiments, the fleet management system 120 uses data sets from one or more AVs 110 to train AV control models. A data set includes sensor data collected by an AVs 110, e.g., while the AV 110 navigates in a scene. The fleet management system 120 determines whether the data set exceeds a privacy budget. The privacy budget indicates a limit on private information (e.g., a limit on an amount of private information) that can be included in the data set. The fleet management system 120 may determine the privacy budget based on data included in the data set (e.g., the type of sensor capturing the data, etc.), the scene where the data set was collected (e.g., privacy policies associated with a region where the scene is located, the type of the scene, etc.), a target accuracy of the control model to be trained with the data set, other factors, or some combination thereof. In some embodiments, the data set includes the privacy budget. The AV 110 may check whether the scene is associated with any privacy budget. For instance, the AV 110 may access a database that stores a look-up table for privacy budgets and finds the privacy budget for the scene, e.g., based on a determination of a location of the scene. An example of the database is the learning datastore 310 described below in conjunction with FIG. 3.

The fleet management system 120 may adjust the data set to meet the privacy budget and use the adjusted data set, which is a privacy-protected data set, to train an AV control model. After the control model is trained, the fleet management system 120 may distribute the control model to AVs 110 operating in a different environment even though the adjusted data set may not meet the privacy budget for the different environment. The fleet management system 120 may have higher computing power than the onboard computer 140. For instance, the fleet management system 120 may have higher processing power, higher data storage capacity, better bandwidth, and so on. More information regarding onboard computer is provided below in conjunction with FIG. 3.

### Example Sensor Suite

FIG. 2 is a block diagram showing the sensor suite 130, according to some embodiments of the present disclosure. The sensor suite 130 includes an exterior sensor 210, a LIDAR sensor 220, a RADAR sensor 230, an interior sensor 240, and a user input sensor 250. The sensor suite 130 may include any number of the types of sensors shown in FIG. 2, e.g., one or more exterior sensor 210, one or more LIDAR sensors 220, etc. The sensor suite 130 may have more types of sensors than those shown in FIG. 2, such as the sensors described with respect to FIG. 1. In other embodiments, the sensor suite 130 may not include one or more of the sensors shown in FIG. 2.

The exterior sensor 210 detects objects in an environment around the AV 110. The environment may include a scene in which the AV 110 navigates. Example objects include persons, buildings, traffic lights, traffic signs, vehicles, street signs, trees, plants, animals, or other types of objects that may be present in the environment around the AV 110. In some embodiments, the exterior sensor 210 includes exterior cameras having different views, e.g., a front-facing camera, a back-facing camera, and side-facing cameras. One or more exterior sensor 210 may be implemented using a high-resolution imager with a fixed mounting and field of view. One or more exterior sensors 210 may have adjustable field of views and/or adjustable zooms. In some embodiments, the exterior sensor 210 may operate continually during operation of the AV 110. In an example embodiment, the exterior sensor 210 captures sensor data (e.g., images, etc.) of a scene in which the AV 110 navigates.

The LIDAR sensor 220 measures distances to objects in the vicinity of the AV 110 using reflected laser light. The LIDAR sensor 220 may be a scanning LIDAR that provides a point cloud of the region scanned. The LIDAR sensor 220 may have a fixed field of view or a dynamically configurable field of view. The LIDAR sensor 220 may produce a point cloud that describes, among other things, distances to various objects in the environment of the AV 110.

The RADAR sensor 230 can measure ranges and speeds of objects in the vicinity of the AV 110 using reflected radio waves. The RADAR sensor 230 may be implemented using a scanning RADAR with a fixed field of view or a dynamically configurable field of view. The RADAR sensor 230 may include one or more articulating RADAR sensors, long-range RADAR sensors, short-range RADAR sensors, or some combination thereof.

The interior sensor 240 detects the interior of the AV 110, such as objects inside the AV 110. Example objects inside the AV 110 include passengers, components of the AV 110, items delivered by the AV 110, items facilitating services provided by the AV 110, and so on. The interior sensor 240 may include multiple interior cameras to capture different views, e.g., to capture views of an interior feature, or portions of an interior feature. The interior sensor 240 may be implemented with a fixed mounting and fixed field of view, or the interior sensor 240 may have adjustable field of views and/or adjustable zooms, e.g., to focus on one or more interior features of the AV 110. The interior sensor 240 may operate continually during operation of the AV 110. The interior sensor 240 may transmit sensor data to a perception module (such as the perception module 530 described below in conjunction with FIG. 5), which can use the sensor data to classify a feature and/or to determine a status of a feature.

### Example Fleet Management System

FIG. 3 is a block diagram showing the fleet management system 120, according to some embodiments of the present disclosure. As shown in FIG. 3, the fleet management system 120 includes a learning datastore 310, a learning module 320, a distributor 330, and a vehicle dispatcher 340. In alternative configurations, different and/or additional components may be included in the fleet management system 120. Further, functionality attributed to one component of the fleet management system 120 may be accomplished by a different component included in the fleet management system 120 or a different system than those illustrated. For instance, some or all of the functions of the learning module 320 may be performed by the onboard computer 140.

The learning datastore 310 stores data associated with training AV control models. For instance, the learning datastore 310 may also store data sets, privacy-protected data sets, hyperparameters used to train control models, internal parameters (e.g., weights) of control models, or other data associated with training AV control models. The learning datastore 310 may also store privacy budgets and information (e.g., privacy policies) used to determine privacy budgets. In an embodiment, the learning datastore 310 stores a look-up table that lists privacy budgets for different regions. The onboard computer of an AV may access the learning datastore 310 to find a privacy budget for a region, such as a region where the AV operates.

In some embodiments, the learning datastore 310 stores environmental sensor data collected by the AVs 110. Some of the learning datastore 310 may be gathered by a fleet of AVs. For example, images obtained by exterior cameras of the AVs may be used to learn information about the AVs' environments. The sensor data may be processed to identify particular objects in the environment. In some embodiments, the learning datastore 310 includes data describing roadways, such as locations of roadways, connections between roadways, roadway names, speed limits, traffic flow regulations, toll information, etc. The learning datastore 310 may further include data describing buildings (e.g., locations of buildings, building geometry, building types, etc.) that may be present in the environments of an AV 110. The learning datastore 310 may also include data describing other objects, such as persons, bike lanes, sidewalks, crosswalks, traffic lights, parking lots, signs, billboards, trees, animals, plants, etc.

In some embodiments, certain sensor data (e.g., sensor data indicating objects that are expected to be temporary) may expire after a certain period of time. In some embodiments, data captured by an AV (e.g., a different AV) may indicate that a previously-observed object is no longer present (e.g., a traffic cone has been removed) and in response, the fleet management system 120 may remove the corresponding sensor data from the learning datastore 310. In some embodiments, the learning datastore 310 stores map data for a city or region in which the AV 110 is located. The learning datastore 310 may store a detailed map of environments through which the fleet of AVs 110 may travel.

The fleet management system 120 and/or AVs 110 may have one or more perception modules (e.g., the perception module 530 described below in conjunction with FIG. 5) to identify objects in the sensor data. Information of these objects may be stored in the learning datastore 310. The learning datastore 310 also stores privacy-protected data generated from sensor data collected by the AVs 110. The privacy-protected data may be generated by adjusting the sensor data, e.g., by removing some or all privacy information included in the sensor data. The learning datastore 310 can also store AV control models that are trained with the privacy-protected data. For instance, the learning datastore 310 may store internal parameters, hyperparameters, or other parameters of AV control models.

The learning module 320 trains AV control models with sensor data collected by AVs. The learning module 320 can train an AV control model with a privacy budget. In some embodiments, the learning module 320 determines whether a data set collected by a sensor suite 130 of an AV 110 meets the privacy budget, e.g., by determining a privacy score. The privacy score indicates a measurement of private information included in the data set. In response to determining that the privacy score is beyond the privacy budget, the learning module 320 adjusts one or more objects included or otherwise indicated in the data set to reduce the privacy information included in the data set. The learning module 320 may adjust more objects until the adjusted privacy score (i.e., the privacy score of the adjusted data set) falls within the privacy budget. A data set that has a privacy score falling within the privacy budget is a privacy-protected data set. The learning module 320 can use such a privacy-protected data set to train an AV control model. The AV control model may be a neural network. In some embodiments, the AV control model is trained based on the privacy-protected data set and knowledge distilled from a pre-trained model. The learning module 320 may further validate a trained AV control model, e.g., based on performance of a simulated AV running with the AV control model. In some embodiments, the learning module 320 validates trained AV control models with privacy-protected data sets.

In some embodiments, the privacy budget is specific to the environment from which the AV 110 collects the sensor data. For instance, the privacy budget is determined based on privacy policies of the environment. The training of the AV control model using the privacy-protected data set may be performed in the same environment or an environment having a higher privacy budget, so that the usage of the privacy-protected data set would not violate the local privacy policies. After the AV control model is trained, the AV control model may be dispatched to AVs 110 that operate in other environments, including environments that have lower privacy budget, as the model itself does not have private information in the data set.

The distributor 330 distributes AV control models trained by the learning module 320 to AVs 110. In some embodiments, the distributor 330 receives a request for an AV control model from an AV. The request may include information of the onboard computer 150 in the AV 110, such as information describing available computing resource on the AV 110. The information describing available computing resource on the AV 110 can be information indicating network bandwidth, information indicating available memory size, information indicating processing power of the AV 110, and so on. In an embodiment, the distributor 330 may instruct the learning module 320 to train an AV control model in accordance with the request. In another embodiment, the distributor 330 may select an AV control model from a group of pre-trained AV control models based on the request. The distributor 330 then transmits the AV control model to the AV 110. In some embodiments, the distributor 330 may provide an AV control model, which is trained based on a privacy-protected data set generated based on privacy policies of a first region, to an AV 110 that operates in a second region. The two regions may have different privacy policies. The privacy-protected data set, which meets the privacy budget for the first region, can be used in the first region to train the AV control model. The AV control model, after trained, can be used in other regions that have different privacy budgets that the privacy-protected data set may not meet.

The vehicle dispatcher 340 assigns the AVs 110 to various tasks (e.g., service tasks) and directs the movements of the AVs 110 in the fleet. In some embodiments, the vehicle dispatcher 340 includes additional functionalities not specifically shown in FIG. 3. For example, the vehicle dispatcher 340 instructs AVs 110 to drive to other locations while not servicing a user, e.g., to improve geographic distribution of the fleet, to anticipate demand at particular locations, etc. The vehicle dispatcher 340 may also instruct AVs 110 to return to an AV facility for fueling, inspection, maintenance, or storage. The vehicle dispatcher 340 may perform some or all of the functions of the onboard computer 140 that are described above in conjunction with FIGS. 1 and 5.

In some embodiments, the vehicle dispatcher 340 selects AVs from the fleet to perform various tasks and instructs the AVs to perform the tasks. In some embodiments, the vehicle dispatcher 340 selects an AV 110 based on availability of the AV 110. For example, the vehicle dispatcher 340 may determine that the AV 110 is available based on a determination that the AV 110 the AV 110 is not performing any task or is going to perform any task that has been assigned to the AV 110. In cases where a service request specifies a time window, the vehicle dispatcher 340 may determine that the AV 110 is available in the time window. In some embodiments (e.g., embodiments where multiple AVs 110 in the AV fleet are available), the vehicle dispatcher 340 may select one of the available AVs based on other factors, such as physical proximity.

The vehicle dispatcher 340 or another system may maintain or access data describing each of the AVs in the fleet of AVs 110, including current location, service status (e.g., whether the AV is available or performing a service; when the AV is expected to become available; whether the AV is schedule for future service), fuel or battery level, etc. The vehicle dispatcher 340 may select AVs for service in a manner that optimizes one or more additional factors, including fleet distribution, fleet utilization, and energy consumption. The vehicle dispatcher 340 may interface with one or more predictive algorithms that project future service requests and/or vehicle use, and select vehicles for services based on the projections.

### Example Learning Module

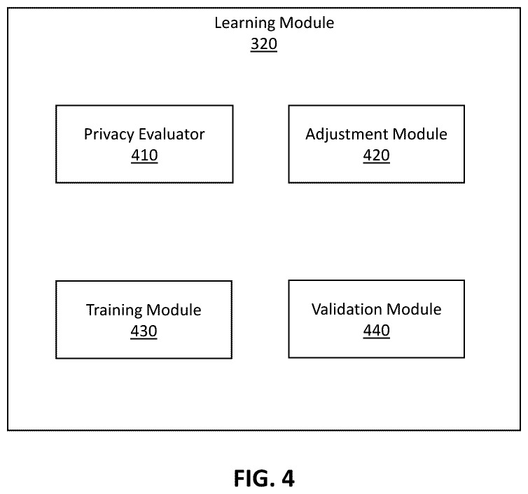

FIG. 4 is a block diagram showing the learning module 320 of the fleet management system 120, according to some embodiments of the present disclosure. The learning module 320 includes a privacy evaluator 410, an adjustment module 420, a training module 430, and a validation module 440. In alternative configurations, fewer, different and/or additional components may be included in the learning module 320. Also, functionality attributed to one component of the learning module 320 may be accomplished by a different component included in the onboard computer 140 or a different system from those illustrated.

The privacy evaluator 410 evaluates whether data sets from AVs 110 meet privacy budgets. A data set from an AV 110 may include sensor data collected by the AV 110, objects identified based on the sensor data, features included in an object identified based on the sensor data, other data captured by the AV 110, or some combination thereof. The data set may be generated by the AV 110 for the purpose of training a model that can be used to control AVs 110. The privacy evaluator 410 may determine a privacy score of a data set. The privacy score is a measurement of private information included the data set. The privacy score may indicate a measurement of the amount of private information included in the data set, a measurement of a potential damage or loss if the private information is disclosed, other types of measurements associated with the private information, or some combination thereof. In various embodiments, private information is information that if disclosed to others, would result in loss of privacy, security, or some other benefit. Private information may include personal identifiable information (e.g., face, name, address, birth date, phone number, identification (ID) number, social security number, etc.), security information (e.g., account number, account name, passcode, etc.), health information (e.g., medical record, etc.), financial information (e.g., bank account information, etc.), conversation information (e.g., messages, audio, etc.), activity information (e.g., information indicating a location of a person, who the person is with and/or what the person is doing at a given time, etc.), or other types of information that if disclosed, a person, a group of person, or an organization would suffer loss of privacy, security, or some other benefit.

In some embodiments, the privacy evaluator 410 determines an individual score for each object in the data set and generates the privacy score by aggregating the individual scores of the objects. The individual score of an object is a measurement of sensitivity of information included in the object or of the object itself. In some embodiments, the privacy evaluator 410 may determine the individual score based on a look-up table, which includes individual scores of various types of objects. In an example, the privacy score may be a sum of the individual scores of the objects. In other embodiments, the privacy evaluator 410 may use a trained model to determine the privacy score. For instance, the privacy evaluator 410 inputs the data set into the model, and the model output the privacy score. The privacy evaluator 410 may train the model based on machine learning techniques. The privacy evaluator 410 may form a training set that includes data sets from AVs 110 and known privacy scores of the data sets and use the training set to train the model.

After determining the privacy score, the privacy evaluator 410 may further compare the privacy score with a privacy budget. The privacy budget indicates a limit on sensitive information that can be included in the data set. The privacy budget may be a threshold privacy score, e.g., a maximum privacy score.

The privacy evaluator 410 may determine the privacy budget based on data included in the data set, the scene where the data set was collected, a target accuracy of the control model to be trained with the data set, other factors, or some combination thereof. In some embodiments, the privacy budget can be set differently for different types of data in the data set. For instance, an image captured by a camera may have a higher privacy budget than a point cloud captured by a LIDAR sensor, because, for example, the point cloud has less information that can be used to identify people. Additionally or alternatively, the privacy budget may be specific to the scene where the data set was collected. For instance, the privacy budget may be determined based on privacy policies of an environment of the scene. The environment may be a region (e.g., country, state, city, etc.) where the scene is located. The privacy policies may include privacy laws (e.g., international laws, national laws, state laws, regional laws, etc.), local rules, industry regulations, internal policies, and so on. In an embodiment, the privacy evaluator 410 determines a privacy budget that is specific to a region (e.g., a country, a state, a city, etc.) as privacy policy may vary for different regions. In another embodiment, the privacy evaluator 410 determines a privacy budget that is specific to a type of scene (e.g., public scene, semi-public scene, private scene, etc.) where the data set was collected.

In some embodiments, the privacy evaluator 410 may determine whether an accuracy of the control model meets a target accuracy. In embodiments where the accuracy of the control model is lower than the target accuracy, the privacy evaluator 410 may modify (e.g., reduce) the privacy budget and train a new model with a new privacy-protected data set generated based on the modified privacy budget, so that the new model can have an accuracy that is equal to or higher than the target accuracy. The privacy evaluator 410 may optimize the privacy budget based on a combination of the goal to protect privacy and the goal to train an accurate control model.

In embodiments where the privacy evaluator 410 determines that the privacy score is higher than the privacy budget, the privacy evaluator 410 may request the adjustment module 420 to modify the data set so that the privacy score of the modified data set would fall into the privacy budget. The privacy evaluator 410 may determine a new privacy score of the modified data set and compares the new privacy score with the privacy budget. In an example where the new privacy score is still higher than the privacy budget, the privacy evaluator 410 may request the adjustment module 420 to further modify the data set until the privacy score becomes no higher than the privacy budget. In embodiments where the privacy evaluator 410 determines that the privacy score is not lower than the privacy budget, the privacy evaluator 410 may transmit the data set to the training module 430 for the training module 430 to train a model by using the data set.

The adjustment module 420 adjusts data sets to make the data sets meet privacy budget. The adjustment module 420 may receive, from the privacy evaluator 410, a data set after the privacy evaluator 410 determines that the privacy score of the data set does not fall in a privacy budget. In some embodiments, the adjustment module 420 may identify private features of objects indicated in the data set and adjust some of all of the identified private features. The adjustment module 420 may determine whether a feature is a private feature by determining whether the feature includes or otherwise indicates private information. For example, a data set, which is generated based on detection of a scene by one or more sensors, may include an image of a person present in the scene, the person is an object indicated by the data set, and the face of the person in the image can be a private feature. As another example, the data set includes an image of a house, the house is an object, and the house numbers can be a private feature. As yet another example, the data set includes an image of a screen in the scene that displays a person's name, the screen is an object, and the text displayed on the screen can be a private feature.

In other embodiments, the adjustment module 420 may use a trained model to identify private features. For instance, the adjustment module 420 inputs the data set into the model, and the model output private features in the data set. The adjustment module 420 may train the model based on machine learning techniques. The adjustment module 420 may form a training set that includes data sets from AVs 110 and known privacy features in the data sets and use the training set to train the model.

After the adjustment module 420 identifies one or more private features in a data set, the adjustment module 420 adjusts some or all of the private features. The adjustment module 420 may obtain (e.g., generate or receive from a user or another module) a list of candidate adjustments. A candidate adjustment may indicate which private feature to adjust and how to adjust a private feature. The candidate adjustments in the list may be different from each other. For instance, different candidate adjustments include different adjustments to a same private feature, adjustments to different private features, or both.

A candidate adjustment may include information specifying one or more private features to adjust and information describing an adjustment for each of the private features. In some embodiments, an adjustment to a private feature is removing or obscuring the whole feature. In other embodiments, the adjustment may be one or more changes to the private feature which can remove the privacy information in the feature but retain other information in the feature, such as information that can be useful or important for training the AV control model. The adjustment module 420 may determine an adjustment to a private feature based on various factors, such as characteristics of the private feature, importance of the private feature for accuracy of the AV control model, one or more private policies associated with the data set (e.g., private policies for the scene where the data set is collected, privacy policies for the region where the data set is used, etc.), other factors, or some combination thereof. In an example where the private feature is a person's face, the adjustment module 420 may determine to replace the face with a virtual face, as opposed to blurring or removing the person's face. The virtual face may be artificially generated based on the sensor data. In an example, the virtual face does not include details based on which the person can be identified, but includes details that are important to train an accurate AV control model, such as details for determining emotion. As another example where the private feature is text, the adjustment module 420 may determine to change content, font, or style of the text, as opposed to removing or blurring the text. For instance, the text may be replaced with different words or numbers of the same or similar style.

After obtaining the candidate adjustments, the adjustment module 420 may further evaluate the candidate adjustments and select one of the candidate adjustments to adjust the data set. In some embodiments, the adjustment module 420 determines a score for each candidate adjustment, ranks the candidate adjustments based on their scores, and select the candidate adjustment having the highest ranking. In an example, for each candidate adjustment, the adjustment module 420 adjusts the data set based on the candidate adjustment and generates a new data set.

The adjustment module 420 may also score the new data set. In some embodiments, the adjustment module 420 determines a privacy score (which can alternatively be determined by the privacy evaluator 410), a behavior score, and a safety score for the new data set. The behavior score indicates an evaluation of operational behaviors of AVs controlled by an AV control model that is trained by using the new data set. The safety score indicates an evaluation of operational safety of AVs controlled by the AV control model that is trained by using the new data set. In some embodiments, the adjustment module 420 instructs the training module 430 to train the AV control model with the new data set, simulates operation of one or more AVs with the AV control model, and determines the behavior score and safety score based on the simulation.

The adjustment module 420 further determines an overall score of the data set, e.g., by aggregating the three scores. In some embodiments, the overall score is a weighted sum of the three scores. The adjustment module 420 may determine a weight for each of the three scores and sums the products of each weight and the corresponding score. The weights of different ones of the three scores may be different. A weight, such as the weight of the privacy score, may be a negative value. A weight, such as the weight of the behavior score or safety score, may be a positive value. In other embodiments, the adjustment module 420 may determine the overall scores of candidate adjustments by using a trained model. For instance, the adjustment module 420 inputs each candidate adjustment into the model, and the model output the score of the candidate adjustment. The adjustment module 420 may train the model based on machine learning techniques. The adjustment module 420 may form a training set that includes adjustments and known scores of the adjustments and use the training set to train the model.

After the adjustment module 420 determines the overall scores of the candidate adjustments, the adjustment module 420 can select one of the candidate adjustments. For instance, the adjustment module 420 ranks the candidate adjustments based on their overall scores and selects the candidate adjustment having the highest ranking. The highest ranked candidate adjustment may have the highest or lowest score, depending on how the scores are calculated. The adjustment module 420 then uses the selected adjustment to adjust the data set and generates a new data set.

In some embodiments, the adjustment module 420 may use a trained model to determine an adjustment for a data set. For instance, the adjustment module 420 inputs the data sets into the model, and the model outputs an adjustment. The adjustment module 420 may have trained the model, e.g., based on machine learning techniques, by using a plurality of data sets and adjustments for the data sets that have been known to be valid adjustments for the plurality of data sets. After the adjustment module 420 obtains the adjustment (e.g., selects the adjustments from candidate adjustments or receives the adjustment from a machine learning model), the adjustment module 420 adjusts the data set based on the adjustment and generates a privacy-protected data set. The adjustment module 420 can provide the privacy-protected data set to the training module to train one or more AV control models.

The training module 430 trains AV control models with privacy-protected data sets. An AV control model controls some or all operation of an AV, such as perception (e.g., classification of objects, etc.), prediction (e.g., prediction of traffic condition, etc.), planning, localization, navigation, or other types of operation of the AV. The training module 430 may receive the privacy-protected data sets from the adjustment module 420. The training module 430 can form a training data set that includes a privacy-protected data set and one or more ground-truth labels of the privacy-protected data set. The ground-truth labels may include, for example, operations of AVs that are considered appropriate, such as operations that are considered safe, operations that can make passengers feel comfortable, etc. In some embodiments, a part of the training data set may be used to initially train the AV control model, and the rest of the training data set may be held back as a validation subset used by the validation module 440 to validate performance of the trained AV control model. The portion of the training data set not including the validation subset may be used to train the AV control model.

In some embodiments (e.g., embodiments where the AV control model is a neural network, such as a deep neural network (DNN)), the training module 430 also determines hyperparameters for training the network. Hyperparameters are variables specifying the network training process. Hyperparameters are different from parameters inside the network (e.g., weights of filters). In some embodiments, hyperparameters include variables determining the architecture of the network, such as number of hidden layers, etc. Hyperparameters also include variables which determine how the network is trained, such as batch size, number of epochs, etc. The training module 430 may also define the architecture of the network, e.g., based on some of the hyperparameters. The architecture of the network includes an input layer, an output layer, and a plurality of hidden layers. The hidden layers include one or more convolutional layers and one or more other types of layers, such as rectified linear unit (ReLU) layers, pooling layers, fully connected layers, normalization layers, softmax or logistic layers, and so on. A convolutional layer of the neural network can abstract input data to a feature map using filters or kernels.

The training module 430 inputs the training data set into the neural network and modifies the parameters inside the network to minimize the error between labels generated by the network based on the privacy-protected data set and the ground-truth labels. The parameters include weights in the convolutional layers of the network. In some embodiments, the training module 430 uses a cost function to minimize the error.

In some embodiments, the training module 430 may train an AV control model through knowledge distillation. The training module 430 may use a “teacher model” and a privacy-protected data set to train a “student model.” The student model can be deployed to an AV, e.g., by the distributor 330, and used as an AV control model. The teacher model is larger than the student model. For instance, the teacher model may include more layers or more nodes than the student model. It may require more computation resource and time to train or apply the teacher model than the student model. In some embodiment, the teacher model is trained separately from the student model. The teacher model may be trained first by using a separate data set. The training module 430 may train the teacher model or obtain the teach model from another system, e.g., a system including high performing processors. The teacher model, in an example, is a DNN that includes a plurality of layers, e.g., convolutional layers, pooling layers, etc. The training module 430 may also design the student model, which may also be a DNN.

The training module 430 may use the pre-trained teacher model to teach the student model what to do, step by step. In some embodiments, the training module 430 provides a privacy-protected data set to both the pre-trained teach model and the to-be-trained student model. Layers (e.g., convolutional layers) of the teacher model outputs feature maps. The training module 430 trains the student model to learn the behavior of the teacher model by trying to replicate these output feature maps, which are referred to as “distilled knowledge.” In an example, the training module 430 may establish correspondence between the student model and the pre-trained teacher model. The correspondence may include passing an output of a layer in the teacher model to the student model. Data augmentation may be performed before passing the output to the student model. In an embodiment, the data may be passed through the teacher model to get intermediate outputs (e.g., outputs of some or all of the layers of the teacher model), then data augmentation is applied to the intermediate outputs. Further, the outputs from the teacher model and the correspondence relation are used to backpropagate error in the student model, and the student model can learn to replicate the behavior of the teacher network.

The training module 430 may also provide one or more ground-truth labels of the privacy-protected data set to the student model and trains the student model based on the distilled knowledge from the teacher model and the ground-truth labels. The training module 430 may use the teacher model to train multiple student models, or use multiple teacher models to train a student model. In addition to or alternative to neural network and knowledge distillation, the training module 430 may train AV control models with other machine learning techniques, such as linear support vector machine, boosting for other algorithms (e.g., AdaBoost), logistic regression, naïve Bayes, memory-based learning, random forests, bagged trees, decision trees, boosted trees, boosted stumps, and so on. Also, in addition to AV control models, the training module 430 may also train other models, such as the above-described models that are used by the privacy evaluator 410 and the adjustment module 420.

The validation module 440 verifies performance of trained AV control models. In some embodiments, the validation module 440 inputs samples in a validation data set into to trained AV control model and uses the output of the AV control model to determine the performance of the AV control model. In some embodiments, a validation data set may be formed of some or all the samples in the training data set. Additionally or alternatively, the validation data set includes additional samples, other than those in the training sets. In some embodiments, the validation module 440 may run a simulation using the AV control model and determine a behavior score and safety score based on the operation of a simulated AV that is controlled by the AV control model. The validation module 440 may further determine a performance score based on the behavior score and safety score, e.g., by determining a weight sum of the behavior score and safety score. The validation module 440 may compare the performance score with a threshold score. In an example where the validation module 440 determines that the performance score of the AV control model is lower than the threshold score, the validation module 440 instructs the training module 430 to re-train or further train the AV control model. In one embodiment, the training module 430 may iteratively re-train the AV control model until the occurrence of a stopping condition, such as the performance score reaching the threshold score, or a number of training rounds having taken place.

### Example Onboard Computer

FIG. 5 is a block diagram showing the onboard computer 140, according to some embodiments of the present disclosure. The onboard computer 140 includes a sensor datastore 510, a sensor interface 520, a perception module 530, a control module 540, and a control model 550. In alternative configurations, fewer, different and/or additional components may be included in the onboard computer 140. For example, components and modules for conducting route planning, controlling movements of the AV 110, and other vehicle functions are not shown in FIG. 5. Further, functionality attributed to one component of the onboard computer 140 may be accomplished by a different component included in the onboard computer 140 or a different system from those illustrated, such as the fleet management system 120.

The sensor datastore 510 stores sensor data from the sensor suite 130, including sensor data collected by the sensor suite 130 in one or more environments around the AV 110. The sensor datastore 510 may store a detailed map of environments through which the AV 110 may travel. The sensor datastore 510 may store environmental objects captured by exterior sensors (e.g., the exterior sensor 210) of the AV 110. Some of the sensor datastore 510 may be gathered by the AV 110. For example, images obtained by exterior sensors (e.g., the exterior sensor 210) of the AV 110 may be used to learn information about the AV's environments. In some embodiments, the sensor datastore 510 may also store sensor data captured by other AVs. The sensor datastore 510 may store data in the learning datastore 310.

The sensor interface 520 interfaces with the sensors in the sensor suite 130. The sensor interface 520 is configured to receive data captured by sensors of the sensor suite 130, including data from exterior sensors mounted to the outside of the AV 110. The sensor interface 520 may have subcomponents for interfacing with individual sensors or groups of sensors of the sensor suite 130, such as a camera interface, a LIDAR interface, a RADAR interface, a microphone interface, etc. The sensor interface 520 may also request data from the sensor suite 130, e.g., by requesting that a sensor capture data in a particular direction or at a particular time.

The perception module 530 identifies objects captured by the sensor suite 130 of the AV 110. For example, the perception module 530 identifies objects in an environment around the AV 110 based on sensor data from one or more exterior sensors (e.g., the exterior sensor 210). In some embodiments, the perception module 530 may include one or more classifiers trained using machine learning to identify objects. In an embodiment, a multi-class classifier may be used to classify each object as one of a set of potential objects. In another embodiment, a class-specific classifier may be used to classify objects in a particular class. For instance, a pedestrian classifier recognizes pedestrians in the environment of the AV 110, a vehicle classifier recognizes vehicles in the environment of the AV 110, etc. The perception module 530 may also identify characteristics of objects based on sensor data. Example characteristics of an object include shape, size, color, material, weight, speed, orientation, and so on.

In some embodiments, the perception module 530 may use data from other sensors (e.g., the LIDAR sensor 220 or the RADAR sensor 230) to identify characteristics or status of an object. For instance, the perception module 530 may identify travel speeds of identified objects based on data from the RADAR sensor 230, e.g., speeds at which other vehicles, pedestrians, or birds are traveling. As another example, the perception module 53—may identify distances to identified object based on data (e.g., a captured point cloud) from the LIDAR sensor 220, e.g., a distance to a particular vehicle, building, or other feature identified by the perception module 530. The perception module 530 fuses data from multiple sources, such as sensors, datastores, other AVs, other systems, etc. In an example, the perception module 530 fuses data from an interior sensor with data from an exterior sensor and/or data from the learning datastore 310 to identify environmental features. While a single perception module 530 is shown in FIG. 5, in some embodiments, the onboard computer 140 may have multiple perception modules, e.g., different perception modules for performing different ones of the perception tasks described above (e.g., object perception, speed perception, distance perception, feature perception, facial recognition, mood determination, sound analysis, gaze determination, etc.).

The control module 540 controls operation of the AV 110 by using the control model 550. The control model 550 is an AV control model trained with privacy-protected data. In some embodiments, the privacy-protected data is a data set generated by the AV 110 or one or more other AVs 110. The data set may include sensor data from the sensor suite 130, objects identified by the perception module 530, or both. In other embodiments, the privacy-protected data is generated by adjusting the data set, e.g., by changing privacy information included in the data set. In some embodiments, the control model is provided by the fleet management system 120.

The control module 540 may provide input data to the control model 550, and the control model 550 outputs operation parameters of the AV 110. The input data includes sensor data from the sensor suite 130 (which may indicate a current state of the AV 110), objects identified by the perception module 530, or both. The operation parameters are parameters indicating operation to be performed by the AV 110. The operation of the AV 110 may include perception, prediction, planning, localization, navigation, other types of operation, or some combination thereof. The control module 540 may provide instructions to various components of the AV 110 based on the output of the control model 550, and these components of the AV 110 will operation in accordance with the instructions. In an example where the output of the control model 500 indicates that a change of traveling speed of the AV 110 is required given a prediction of traffic condition, the control module 540 may instruct the motor of the AV 110 to change the traveling speed of the AV 110. In another example where the output of the control model 500 indicates a need to detect characteristics of an object in the environment around the AV 110 (e.g., detect a speed limit), the control module 540 may instruct the sensor suite 130 to capture an image of the speed limit sign with sufficient resolution to read the speed limit and instruct the perception module 530 to identify the speed limit in the image.

### Example Scene

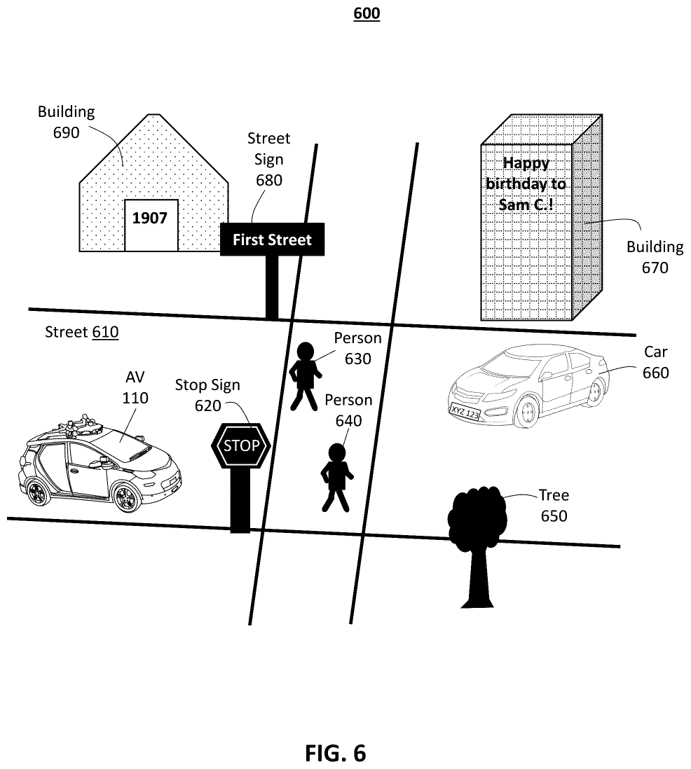

FIG. 6 illustrates an example scene 600 in which an AV 110 collects sensor data, according to some embodiments of the present disclosure. The scene 600 may be a scene in a real-world environment, such as a city, etc. The AV 110 may travel in the scene 600, e.g., along a street 610. The AV 110 may be controlled by an AV control model, such as the control model 550. During the presence of the AV 110 in the scene 600, the sensor suite 130 of the AV 110 detects the scene, including objects present in the scene 600, and generates the sensor data.

As shown in FIG. 6, the objects present in the scene 600 include a stop sign 620, persons 630 and 640, a tree 650, a car 660, a building 670, a street sign 680, and another building 690. The sensor data collected by the AV 110 capture features of these objects, which may include private features. For instance, the sensor data may include one or more images, which can include images capturing the face of the person 630 or 640, the license plate of the car 660, the text displayed on a screen of the building 670 which indicates a birthday and a name of a person, the street sign 680, and the house number on the building 690. These features include private information that if publicly disclosed, would result in loss of privacy.

The sensor data may be adjusted to privacy-protected data. In some embodiments, some or all of the private features that are detected can be removed or obscured, e.g., based on a determination that the private feature would not be critical or useful for training the AV control model. For instance, the house number on the building 690 and the license plate of the car 660 can be obscured.

In other embodiments, a private feature may be partially modified, meaning some information (e.g., the private information) in the feature is removed but some other information (e.g., information that can be critical for training an AV control model) is retained. For example, the person's face (or the person) may be replaced with a virtual representation, such as avatar. The virtual representation would have the position, posture, emotion, walking speed, or other types of characteristics of the person that indicates a status of the person that the AV 110 needs to be aware of. Such characteristics of the person can useful for training the AC control model, e.g., it is important for the AC control model to predict traffic condition around the AV 110. Facial characteristics (e.g., eye size, hair, face shape, etc.) that can be used to identify the person are changed to remove private information in the sensor data. As another example, the text displayed on the screen of the building 670 may be changed, as opposed to be removed or obscured because the displayed text may be useful for training the AV control model as it changes lighting condition around the AV 110. For instance, the text can be shuffled, scrambled, or replaced with different words of similar style (e.g., words including same or similar number of letters and having same or similar font). “Sam C.” may be replaced by “Doe J.” to remove the real name from the text.

### Example Process of Training Model with Knowledge Distillation

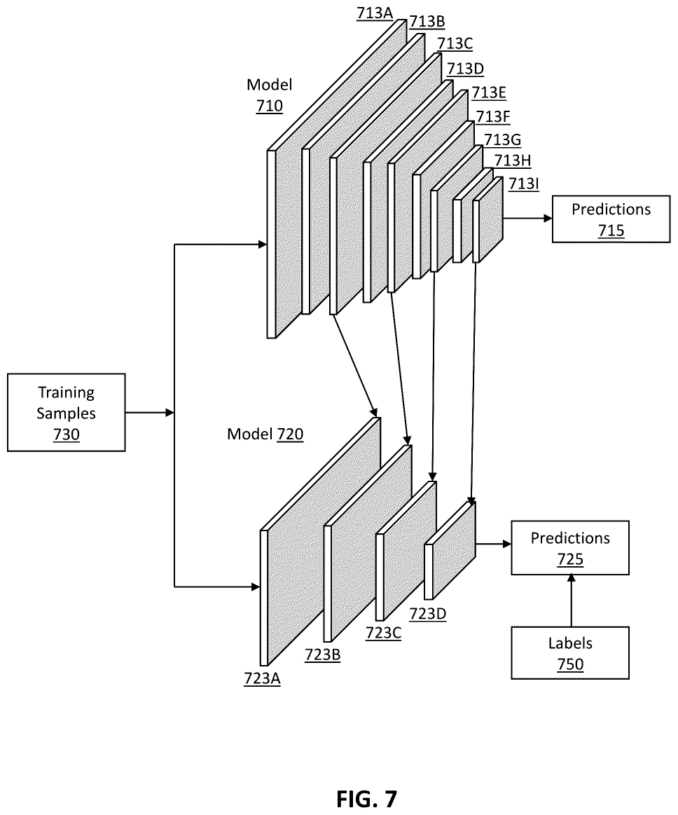

FIG. 7 illustrates training a model 720 by using knowledge distillation, according to some embodiments of the present disclosure. The model 720 may be an AV control model. FIG. 7 also shows a model 710. In some embodiments, the models 710 and 720 are DNNs that includes a plurality of hidden layers, such as convolutional layers, pooling layers, fully-connected layers, and so on. As shown in FIG. 7, the model 710 includes layers 713A-H (collectively referred to as “layers 713” or “layers 713”), the model 720 includes layers 723A-D (collectively referred to as “layers 723” or “layers 723”). The model 710 has a larger size than the model 720. As shown in FIG. 7, the number of layers 713 is more than the number of layers 723. For purpose of illustration, FIG. 7 shows nine layers 713 and four layers 723. In other embodiments, the model 710 or 720 may include more, fewer, or different layers.

In some embodiments, the model 710 is pre-trained (e.g., internal parameters of the model 710 have been determined), and the model 720 is to-be-trained by using the model 710 and training data. The model 710 may be a teacher model, and the model 720 may be a student model. To train the model 720, training samples 730 are input into both models 710 and 720. The training samples 730 may be from one or more privacy-protected data sets. The model 710 uses the training samples 730 to make predictions 715, e.g., based on the internal parameters of the model 710. The predictions 715 may be generated based on feature maps output from some of the layers 713, such as the layers 713C, 713E, 713G, and 713I. Different layers of the model 710 may output different feature maps by using different internal parameters, e.g., weights of filters.

The model 720 uses the training samples 730 to make predictions 725, e.g., based on the internal parameters of the model 720. The model 720 also receives the feature maps output from the layers 713C, 713E, 713G, and 713I and labels 750 for the training samples 730. The internal parameters of the model 720 are adjusted based on the feature maps and the labels 750. For purpose of simplicity and illustration, in the embodiments of FIG. 7, the layer 723A receives the feature map 713C, the layer 723B receives the feature map 713E, the layer 723C receives the feature map 713G, and the layer 723D receives the feature map 713I. The internal parameters in each layer 723 may be adjusted to minimize a difference between the output of the layer 723 and the feature map from the corresponding layer 713. Also, internal parameters of the model 720 can be adjusted to minimize a difference between the predictions 725 and the labels 750. In some embodiments, the internal parameters of the model 720 are be adjusted by using one or more loss functions or cost functions.

In the training of the model 720, the output feature maps from the pre-trained model 710 constitute the knowledge distilled from the model 710 and used to train the model 720. In some embodiments, the distilled knowledge from the pre-trained model 710 may include output feature maps from some or all of the convolutional layers in the model 710. By using knowledge distillation, the model 720 can be trained to learn the behavior of the model 710 by trying to replicate the layer-level outputs of the model 710. It can also be considered that the model 720 is trained by “compressing” the model 710 as the model 720 has a smaller size. The model 720, since it has a smaller size, can be used by systems with limited computation resources, such as the onboard computer 140, versus the training of the models 710 and 720 can be done by a system with more computation resources, such as the fleet management system 120.

### Example Method of Training AV Control Model with Privacy Budget

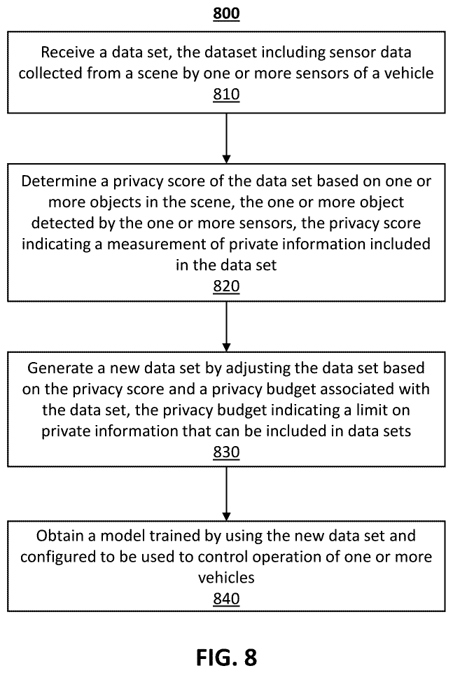

FIG. 8 is a flowchart showing a method 800 of training an AV control model with a privacy budget, according to some embodiments of the present disclosure. The method 800 may be performed by the learning module 320. Although the method 800 is described with reference to the flowchart illustrated in FIG. 8, many other methods of training an AV control model with a privacy budget may alternatively be used. For example, the order of execution of the steps in FIG. 8 may be changed. As another example, some of the steps may be changed, eliminated, or combined.

The learning module 320 receives, in 810, a data set. The data set includes sensor data collected from a scene by one or more sensors of a vehicle. In some embodiments, the scene is a real-world scene. The data set may also include other information associated with the scene, e.g., information identifying objects captured by the sensor data.

The learning module 320 determines, in 820, a privacy score of the data set based on one or more objects in the scene. The one or more objects are detected by the one or more sensors. The privacy score indicates a measurement of private information included in the data set. Privacy information may be information that if disclosed, would result in a loss of privacy, security, or advantage. In some embodiments, the learning module 320 determines one or more individual scores for the one or more objects. Each individual score corresponds to a respective object of the one or more objects and indicates a measurement of private information indicated in the respective object. The privacy score of the dataset or individual score of an object may be based on an estimated monetary value of the dataset or object. The score may be based on a ranking system based on severity of consequences of the corresponding information shared, becoming public or misused. For example, a privacy score may be set to 1 for highly private information, versus 10 for public information. The learning module 320 determines the privacy score by aggregating the one or more individual scores. For instance, the privacy score may be a sum, weighted sum, median, or mean of the individual scores.

The learning module 320 generates, in 830, a new data set by adjusting the data set based on the privacy score and a privacy budget associated with the data set. The privacy budget indicates a limit on private information that can be included in data sets. The privacy budget may be determined based on one or more privacy policies associated with the scene, such as privacy policies of a region (e.g., a country, state, province, county, city, etc.) where the scene is located. In some embodiments, the privacy budget can be calculated operationally by launching a service provided by AVs in an area, collecting data for a sufficient period of time (e.g., 1 month-1 year), analyzing the data for conditions where privacy in data is acceptable or unacceptable, and finding a level for the privacy budget that optimally separates the acceptable and unacceptable conditions. For example, if a privacy value for an acceptable condition is 200 versus 250 for an unacceptable condition, the privacy budget can be set at 225. Extra levels of privacy protection may be used during the data collection while the privacy budget is being determined to ensure that privacy is not violated in that period as well. The learning module 320 may compare the privacy score with the privacy budget. In response to determining that the privacy score is higher than the privacy budget, the learning module 320 adjusts the data set. In some embodiments, the learning module 320 adjusts the data set by selecting an object from the one or more objects in the data set. The object includes a privacy feature that is capture by the sensor data. The learning module 320 generates a new object from the object by modifying the privacy feature. The learning module 320 may remove first information (e.g., information that is not private but can be useful or even critical for training the AV control model) in the privacy feature and retaining second information (e.g., private information) in the privacy feature. Removing the information may comprise removing data features that convey the information. As an example, removing the data features may be removal of a face, letters or numbers from the image. Retaining the information may comprise retaining the data features that convey the information. As an example, retaining the data features may be keeping the face, letters or numbers in the image intact. The learning module 320 further adjusts the data set by replacing the object with the new object. Replacing the object may comprise removing the object from the data set, and then inserting a different object in the data set at the same spatial and temporal location of the removed object.

In some embodiments, the learning module 320 obtains a plurality of candidate adjustments to the data set. Each candidate adjustment includes information specifying an object of the one or more objects and information describing an adjustment to the object. The learning module 320 selects a candidate adjustment from the plurality of candidate adjustments and uses the candidate adjustment to adjust the data set. The learning module 320 may determine an adjusted privacy score and a performance score for each candidate adjustment. The adjusted privacy score indicates a measurement of private information included in an adjusted data set generated by adjusting the data set with the respective candidate adjustment. The performance score indicates an evaluation of performance of a vehicle controlled by a model trained with the adjusted data set. The performance score may be an aggregation (e.g., a weighted sum) of a behavior score and a safety score. The learning module 320 may rank the plurality of candidate adjustments based on the adjusted privacy score and performance score of each respective candidate adjustment and selects the candidate adjustment based on the ranking. For instance, the learning module 320 may determine an overall score for each respective candidate adjustment by aggregating the adjusted privacy score and performance score. The overall score may be a weighted sum of the adjusted privacy score and performance score. The learning module 320 then ranks the plurality of candidate adjustments based on overall scores of the plurality of candidate adjustments.

The learning module 320 obtains, in 840, a model. The model is trained by using the new data set. In some embodiments, the learning module 320 trains the model with the new data set. The learning module 320 may provide the new data set to a pre-trained model. The pre-trained model is configured to output feature maps. The learning module 320 trains the model with the new data set and the feature maps from the pre-trained model. The model is configured to be used to control operation of one or more vehicles. In some embodiments, the scene is located in a first environment, and the one or more vehicles are configured to operate in a second environment different from the first environment.

### Select Examples

Example 1 provides a method, including receiving a data set, the data set including sensor data collected from a scene by one or more sensors of a vehicle; determining a privacy score of the data set based on one or more objects in the scene, the one or more objects detected by the one or more sensors, the privacy score indicating a measurement of private information included in the data set; generating a new data set by adjusting the data set based on the privacy score and a privacy budget associated with the data set, the privacy budget indicating a limit on private information that can be included in data sets; and obtaining a model trained by using the new data set and configured to be used to control operation of one or more vehicles.

Example 2 provides the method of example 1, where determining the privacy score includes determining one or more individual scores for the one or more objects, each individual score corresponding to a respective object of the one or more objects and indicating a measurement of private information indicated in the respective object; and determining the privacy score by aggregating the one or more individual scores.

Example 3 provides the method of example 1, where adjusting the data set based on the privacy score and a privacy budget includes comparing the privacy score with the privacy budget; and in response to determining that the privacy score is higher than the privacy budget, adjusting the data set.

Example 4 provides the method of example 1, where adjusting the data set includes selecting an object from the one or more objects, the object including a privacy feature; generating a new object from the object by modifying the privacy feature; and adjusting the data set by replacing the object with the new object.

Example 5 provides the method of example 4, where modifying the privacy feature includes removing first information in the privacy feature and retaining second information in the privacy feature.

Example 6 provides the method of example 1, where adjusting the data set includes obtaining a plurality of candidate adjustments to the data set, each candidate adjustment including information specifying an object of the one or more objects and information describing an adjustment to the object; selecting a candidate adjustment from the plurality of candidate adjustments; and using the candidate adjustment to adjust the data set.

Example 7 provides the method of example 6, where selecting a candidate adjustment from the plurality of candidate adjustments includes for each respective candidate adjustment of the plurality of candidate adjustments: determining an adjusted privacy score indicating a measurement of private information included in an adjusted data set generated by adjusting the data set with the respective candidate adjustment, and determining a performance score indicating an evaluation of performance of a vehicle controlled by a model trained with the adjusted data set; ranking the plurality of candidate adjustments based on the adjusted privacy score and performance score of each respective candidate adjustment; and selecting the candidate adjustment based on the ranking.

Example 8 provides the method of example 7, where ranking the plurality of candidate adjustments based on the adjusted privacy score and performance score of each respective candidate adjustment includes determining an overall score for each respective candidate adjustment by aggregating the adjusted privacy score and performance score; and ranking the plurality of candidate adjustments based on overall scores of the plurality of candidate adjustments.

Example 9 provides the method of example 1, where obtaining the model includes providing the new data set to a pre-trained model, the pre-trained model configured to output feature maps; and training the model with the new data set and the feature maps from the pre-trained model.

Example 10 provides the method of example 1, where the scene is located in a first environment, and the one or more vehicles are configured to operate in a second environment different from the first environment.

Example 11 provides one or more non-transitory computer-readable media storing instructions executable to perform operations, the operations including receiving a data set, the data set including sensor data collected from a scene by one or more sensors of a vehicle; determining a privacy score of the data set based on one or more objects in the scene, the one or more objects detected by the one or more sensors, the privacy score indicating a measurement of private information included in the data set; generating a new data set by adjusting the data set based on the privacy score and a privacy budget associated with the data set, the privacy budget indicating a limit on private information that can be included in data sets; and obtaining a model trained by using the new data set and configured to be used to control operation of one or more vehicles.

Example 12 provides the one or more non-transitory computer-readable media of example 11, where determining the privacy score includes determining one or more individual scores for the one or more objects, each individual score corresponding to a respective object of the one or more objects and indicating a measurement of private information indicated in the respective object; and determining the privacy score by aggregating the one or more individual scores.

Example 13 provides the one or more non-transitory computer-readable media of example 11, where adjusting the data set includes selecting an object from the one or more objects, the object including a privacy feature; generating a new object from the object by modifying the privacy feature; and adjusting the data set by replacing the object with the new object.

Example 14 provides the one or more non-transitory computer-readable media of example 11, where adjusting the data set includes obtaining a plurality of candidate adjustments to the data set, each candidate adjustment including information specifying an object of the one or more objects and information describing an adjustment to the object; selecting a candidate adjustment from the plurality of candidate adjustments; and using the candidate adjustment to adjust the data set.

Example 15 provides the one or more non-transitory computer-readable media of example 14, where selecting a candidate adjustment from the plurality of candidate adjustments includes for each respective candidate adjustment of the plurality of candidate adjustments: determining an adjusted privacy score indicating a measurement of private information included in an adjusted data set generated by adjusting the data set with the respective candidate adjustment, and determining a performance score indicating an evaluation of performance of a vehicle controlled by a model trained with the adjusted data set; ranking the plurality of candidate adjustments based on the adjusted privacy score and performance score of each respective candidate adjustment; and selecting the candidate adjustment based on the ranking.

Example 16 provides the one or more non-transitory computer-readable media of example 11, where obtaining the model includes providing the new data set to a pre-trained model, the pre-trained model configured to output feature maps; and training the model with the new data set and the feature maps from the pre-trained model.

Example 17 provides the one or more non-transitory computer-readable media of example 11, where the scene is located in a first environment, and the one or more vehicles are configured to operate in a second environment different from the first environment.

Example 18. A computer system, including a computer processor for executing computer program instructions; and one or more non-transitory computer-readable media storing computer program instructions executable by the computer processor to perform operations including: receiving a data set, the data set including sensor data collected from a scene by one or more sensors of a vehicle; determining a privacy score of the data set based on one or more objects in the scene, the one or more objects detected by the one or more sensors, the privacy score indicating a measurement of private information included in the data set; generating a new data set by adjusting the data set based on the privacy score and a privacy budget associated with the data set, the privacy budget indicating a limit on private information that can be included in data sets; and obtaining a model trained by using the new data set and configured to be used to control operation of one or more vehicles.

Example 19 provides the computer system of example 18, where determining the privacy score includes determining one or more individual scores for the one or more objects, each individual score corresponding to a respective object of the one or more objects and indicating a measurement of private information indicated in the respective object; and determining the privacy score by aggregating the one or more individual scores.

Example 20 provides the computer system of example 18, where obtaining the model includes providing the new data set to a pre-trained model, the pre-trained model configured to output feature maps; and training the model with the new data set and the feature maps from the pre-trained model.

### OTHER IMPLEMENTATION NOTES, VARIATIONS, AND APPLICATIONS

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

What is claimed is:

1. A method, comprising:
receiving a data set, the data set including sensor data collected from a scene by one or more sensors of a vehicle;
determining a privacy score of the data set based on one or more objects in the scene, the one or more objects detected by the one or more sensors, the privacy score indicating a measurement of private information included in the data set;
generating a new data set by adjusting the data set based on the privacy score and a privacy budget associated with the data set, the privacy budget indicating a limit on private information that can be included in data sets; and
obtaining a model trained by using the new data set and configured to be used to control operation of one or more vehicles.

2. The method of claim 1, wherein determining the privacy score comprises:
determining one or more individual scores for the one or more objects, each individual score corresponding to a respective object of the one or more objects and indicating a measurement of private information indicated in the respective object; and
determining the privacy score by aggregating the one or more individual scores.

3. The method of claim 1, wherein adjusting the data set based on the privacy score and a privacy budget comprises:
comparing the privacy score with the privacy budget; and
in response to determining that the privacy score is higher than the privacy budget, adjusting the data set.

4. The method of claim 1, wherein adjusting the data set comprises:
selecting an object from the one or more objects, the object including a privacy feature;
generating a new object from the object by modifying the privacy feature; and
adjusting the data set by replacing the object with the new object.

5. The method of claim 4, wherein modifying the privacy feature comprises:
removing first information in the privacy feature and retaining second information in the privacy feature.

6. The method of claim 1, wherein adjusting the data set comprises:
obtaining a plurality of candidate adjustments to the data set, each candidate adjustment including information specifying an object of the one or more objects and information describing an adjustment to the object;
selecting a candidate adjustment from the plurality of candidate adjustments; and
using the candidate adjustment to adjust the data set.

7. The method of claim 6, wherein selecting a candidate adjustment from the plurality of candidate adjustments comprises:
for each respective candidate adjustment of the plurality of candidate adjustments:
determining an adjusted privacy score indicating a measurement of private information included in an adjusted data set generated by adjusting the data set with the respective candidate adjustment, and
determining a performance score indicating an evaluation of performance of a vehicle controlled by a model trained with the adjusted data set;
ranking the plurality of candidate adjustments based on the adjusted privacy score and performance score of each respective candidate adjustment; and
selecting the candidate adjustment based on the ranking.

8. The method of claim 7, wherein ranking the plurality of candidate adjustments based on the adjusted privacy score and performance score of each respective candidate adjustment comprises:
determining an overall score for each respective candidate adjustment by aggregating the adjusted privacy score and performance score; and
ranking the plurality of candidate adjustments based on overall scores of the plurality of candidate adjustments.

9. The method of claim 1, wherein obtaining the model comprises:
providing the new data set to a pre-trained model, the pre-trained model configured to output feature maps; and
training the model with the new data set and the feature maps from the pre-trained model.

10. The method of claim 1, wherein the scene is located in a first environment, and the one or more vehicles are configured to operate in a second environment different from the first environment.

11. One or more non-transitory computer-readable media storing instructions executable to perform operations, the operations comprising:
receiving a data set, the data set including sensor data collected from a scene by one or more sensors of a vehicle;
determining a privacy score of the data set based on one or more objects in the scene, the one or more objects detected by the one or more sensors, the privacy score indicating a measurement of private information included in the data set;
generating a new data set by adjusting the data set based on the privacy score and a privacy budget associated with the data set, the privacy budget indicating a limit on private information that can be included in data sets; and
obtaining a model trained by using the new data set and configured to be used to control operation of one or more vehicles.

12. The one or more non-transitory computer-readable media of claim 11, wherein determining the privacy score comprises:
determining one or more individual scores for the one or more objects, each individual score corresponding to a respective object of the one or more objects and indicating a measurement of private information indicated in the respective object; and
determining the privacy score by aggregating the one or more individual scores.

13. The one or more non-transitory computer-readable media of claim 11, wherein adjusting the data set comprises:
selecting an object from the one or more objects, the object including a privacy feature;
generating a new object from the object by modifying the privacy feature; and
adjusting the data set by replacing the object with the new object.

14. The one or more non-transitory computer-readable media of claim 11, wherein adjusting the data set comprises:
obtaining a plurality of candidate adjustments to the data set, each candidate adjustment including information specifying an object of the one or more objects and information describing an adjustment to the object;
selecting a candidate adjustment from the plurality of candidate adjustments; and
using the candidate adjustment to adjust the data set.

15. The one or more non-transitory computer-readable media of claim 14, wherein selecting a candidate adjustment from the plurality of candidate adjustments comprises:
for each respective candidate adjustment of the plurality of candidate adjustments:
determining an adjusted privacy score indicating a measurement of private information included in an adjusted data set generated by adjusting the data set with the respective candidate adjustment, and
determining a performance score indicating an evaluation of performance of a vehicle controlled by a model trained with the adjusted data set;
ranking the plurality of candidate adjustments based on the adjusted privacy score and performance score of each respective candidate adjustment; and
selecting the candidate adjustment based on the ranking.

16. The one or more non-transitory computer-readable media of claim 11, wherein obtaining the model comprises:
providing the new data set to a pre-trained model, the pre-trained model configured to output feature maps; and
training the model with the new data set and the feature maps from the pre-trained model.

17. The one or more non-transitory computer-readable media of claim 11, wherein the scene is located in a first environment, and the one or more vehicles are configured to operate in a second environment different from the first environment.

18. A computer system, comprising:
a computer processor for executing computer program instructions; and
one or more non-transitory computer-readable media storing computer program instructions executable by the computer processor to perform operations comprising:
receiving a data set, the data set including sensor data collected from a scene by one or more sensors of a vehicle;
determining a privacy score of the data set based on one or more objects in the scene, the one or more objects detected by the one or more sensors, the privacy score indicating a measurement of private information included in the data set;
generating a new data set by adjusting the data set based on the privacy score and a privacy budget associated with the data set, the privacy budget indicating a limit on private information that can be included in data sets; and
obtaining a model trained by using the new data set and configured to be used to control operation of one or more vehicles.

19. The computer system of claim 18, wherein determining the privacy score comprises:
determining one or more individual scores for the one or more objects, each individual score corresponding to a respective object of the one or more objects and indicating a measurement of private information indicated in the respective object; and
determining the privacy score by aggregating the one or more individual scores.

20. The computer system of claim 18, wherein obtaining the model comprises:
providing the new data set to a pre-trained model, the pre-trained model configured to output feature maps; and
training the model with the new data set and the feature maps from the pre-trained model.
